(19) United States
(12) Patent Application Publication
(10) Pub. No.: US 2026/0311932 A1
(43) Pub. Date: Oct. 8, 2026

(54) MULTILAYER ELECTRONIC COMPONENT

(71) Applicant: SAMSUNG ELECTRO-MECHANICS CO., LTD., Suwon-si (KR)

(72) Inventors: Hyun KIM, Suwon-si (KR); Dong Jun JUNG, Suwon-si (KR); Won Mi CHOI, Suwon-si (KR); Ji Hye AHN, Suwon-si (KR); Byung Kun KIM, Suwon-si (KR); Yu Hong OH, Suwon-si (KR)

(73) Assignee: SAMSUNG ELECTRO-MECHANICS CO., LTD., Suwon-si (KR)

(21) Appl. No.: 19/545,307

(22) Filed: Feb. 20, 2026

(30) Foreign Application Priority Data
Apr. 3, 2025 (KR) 10-2025-0043310

(51) Int. Cl. H01G 4/12; H01G 4/008; H01G 4/30

(52) U.S. Cl. CPC H01G 4/1227; H01G 4/008; H01G 4/30

(57) ABSTRACT

A multilayer electronic component may include: a body including a dielectric layer including Ba, Ti, and Ge, and internal electrodes disposed alternately with the dielectric layers; and an external electrode disposed on the body, and the dielectric layer may include a plurality of dielectric grains and grain boundaries disposed between adjacent dielectric grains, and an average Ge content relative to Ti in the grain boundaries may be 0.2 at % or more and 4.5 at % or less.

### CROSS-REFERENCE TO RELATED APPLICATION(S)

This application claims benefit of priority to Korean Patent Application No. 10-2025-0043310 filed on Apr. 3, 2025, in the Korean Intellectual Property Office, the disclosure of which is incorporated herein by reference in its entirety.

### TECHNICAL FIELD

The present disclosure relates to a multilayer electronic component.

Multilayer Ceramic Capacitor (MLCC), a multilayer electronic component, is a chip-type capacitor mounted on the printed circuit boards of various electronic products such as Liquid Crystal Displays (LCD) and plasma display panels (PDP), computers, smartphones, and mobile phones to charge electricity therein or discharge electricity therefrom. The MLCC is used as a component of various electronic devices due to having a small size, high capacity, and ease of mounting.

In order to miniaturize the MLCC, the dielectric layer and the internal electrode of MLCC should be thinned. However, as the thickness of the dielectric layer and the internal electrode decreases, the electric field strength applied to the dielectric layer and the internal electrode of the first layer becomes relatively strong, and accordingly, there may be a problem that the high-temperature reliability and moisture-resistant reliability of MLCC are deteriorated.

### SUMMARY

An aspect of the present disclosure is to provide a multilayer electronic component having excellent reliability.

However, the aspects of the present disclosure are not limited to the above-described contents, and may be more easily understood in the process of describing specific embodiments of the present disclosure.

A multilayer electronic component according to an example embodiment of the present disclosure may include: a body including a dielectric layer including Ba, Ti, and Ge, and internal electrodes disposed alternately with the dielectric layers; and an external electrode disposed on the body, wherein the dielectric layer includes a plurality of dielectric grains, and grain boundaries disposed between adjacent dielectric grains, and an average Ge content relative to Ti at the grain boundaries may be 0.2 at % or more and 4.5 at % or less.

One effect of the present disclosure is to provide a multilayer electronic component having excellent reliability.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 is a cross-sectional view schematically illustrating a cross-section taken along line I-I′ of FIG. 1;

FIG. 3 is a cross-sectional view schematically illustrating a cross-section taken along line II-II′ of FIG. 1;

FIG. 4 is an exploded perspective view schematically illustrating a body of FIG. 1;

FIG. 5 is an enlarged view schematically illustrating region K of FIG. 2;

FIG. 6 is an image obtained by capturing a dielectric layer and an internal electrode using a scanning transmission electron microscope (STEM); and

FIG. 7 is an image obtained by capturing a grain boundary of a dielectric layer with a scanning transmission electron microscope (STEM).

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In the drawing, an X-direction may be defined as a thickness (T) direction, a Y-direction as a length (L) direction, and a Z-direction as a width (W) direction. In the present disclosure, “thickness” may refer to the size in the thickness direction, “length” may refer to the size in the length direction, and “width” may refer to the size in the width direction.

### Multilayer Electronic Component

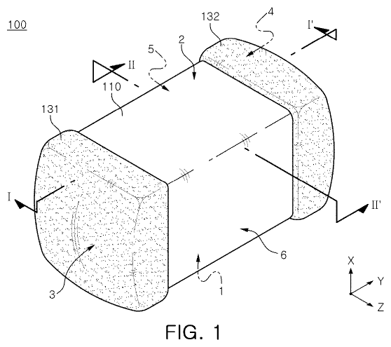

FIG. 1 is a perspective view schematically illustrating a multilayer electronic component according to an example embodiment of the present disclosure.

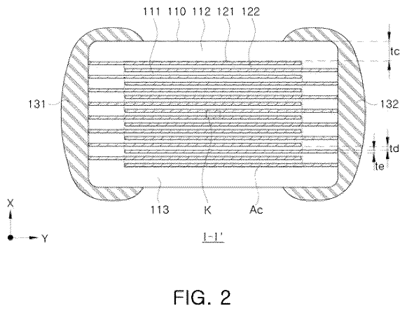

FIG. 2 is a cross-sectional view schematically illustrating a cross-section taken along line I-I′ of FIG. 1.

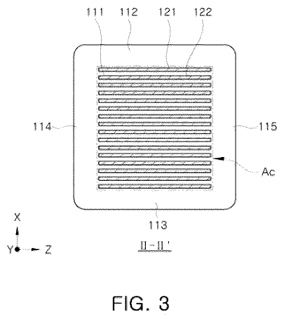

FIG. 3 is a cross-sectional view schematically illustrating a cross-section taken along line II-II′ of FIG. 1.

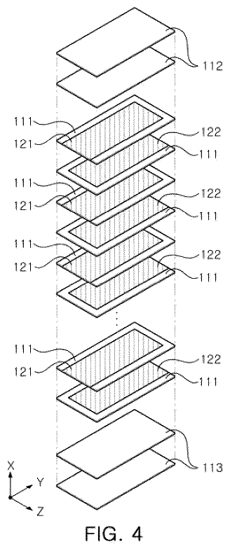

FIG. 4 is an exploded perspective view schematically illustrating a body of FIG. 1.

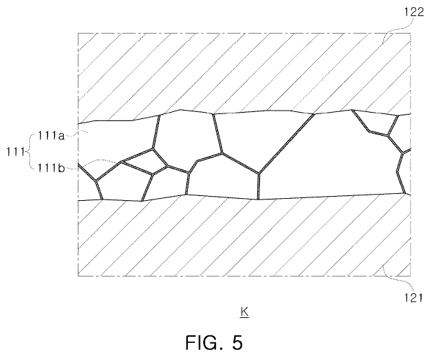

FIG. 5 is an enlarged view schematically illustrating region K of FIG. 2.

Hereinafter, a multilayer electronic component 100 according to an example embodiment of the present disclosure will be described in detail with reference to FIGS. 1 to 5. Furthermore, a multilayer ceramic capacitor will be described as an example of a multilayer electronic component. However, the present disclosure is not limited thereto and may be applied to various multilayer electronic components, such as inductors, piezoelectric elements, varistors, or thermistors.

A length of the multilayer electronic component 100 may be more than a width and a thickness of the multilayer electronic component 100, respectively, but the present disclosure is not limited thereto. For example, the length of the multilayer electronic component 100 may be narrower than the width of the multilayer electronic component 100. The width of the multilayer electronic component 100 may be smaller or larger than the thickness of the multilayer electronic component 100, which may vary depending on the target specifications or characteristics of the multilayer electronic component 100.

A multilayer electronic component 100 according to an example embodiment of the present disclosure may include a body 110 and external electrodes 131 and 132 disposed on the body 110.

While there are no particular limitations on the specific shape of the body 110, as illustrated, the body 110 may be formed in a hexahedral shape or a shape similar thereto. Due to shrinkage of ceramic powder particles included in the body 110 during a sintering process or a polishing process on corners of the body 110, the body 110 may not have a perfectly straight hexahedral shape, but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3 and 4 and opposing each other in the width direction.

The body 110 may include a dielectric layer 111 and internal electrodes 121 and 122 alternately disposed with the dielectric layers 111. A plurality of dielectric layers 111 forming the body 110 are in a sintered state, and boundaries between adjacent dielectric layers 111 may be integrated to be difficult to identify without using a scanning electron microscope (SEM).

The body 110 may include a capacitance formation portion Ac that forms a capacitance, by including a first internal electrode 121 and a second internal electrode 122 that are alternately disposed with the dielectric layer 111 interposed therebetween. The internal electrodes 121 and 122 may be stacked in the thickness direction or the width direction. The present disclosure will be described based on an example embodiment in which the stacking direction of the internal electrodes 121 and 122 is a thickness direction.

The first internal electrode 121 may be spaced apart from the fourth surface 4 and connected to a first external electrode 131 on the third surface 3. The second internal electrode 122 may be spaced apart from the third surface 3 and connected to a second external electrode 132 on the fourth surface 4.

The body 110 may include cover portions 112 and 113 disposed on opposite surfaces of the capacitance formation portion Ac opposing each other in the thickness direction, and margin portions 114 and 115 disposed on opposite surfaces of the capacitance formation portion Ac opposing each other in the width direction. The cover portions 112 and 113 and the margin portions s 114 and d 115 may have a similar configuration to the dielectric layer 111, except that the cover portions 112 and 113 and the margin portions 114 and 115 do not include internal electrodes.

The external electrodes 131 and 132 may include a first external electrode 131 disposed on the third surface 3 and extending onto portions of the first, second, fifth and sixth surfaces 1, 2, 5 and 6, and a second external electrode 132 disposed on the fourth surface 4 and extending onto portions of the first, second, fifth and sixth surfaces 1, 2, 5 and 6.

The type or shape of the external electrodes 131 and 132 is not particularly limited, and the external electrodes 131 and 132 may have a multilayer structure. For example, the external electrodes 131 and 132 may include a base electrode layer in contact with the internal electrodes 121 and 122 and a plating layer disposed on the base electrode layer.

The base electrode layer may be a sintered electrode layer including a metal and glass. The metal included in the sintered electrode layer may include, for example, Cu, Ni, Pd, Pt, Au, Ag, Pb, and/or alloys including the same. The glass included in the sintered electrode layer may include, for example, one or more oxides of Ba, Ca, Zn, Al, B and Si.

The base electrode layer may consist solely of a sintered electrode layer, but the present disclosure is not limited thereto, and the base electrode layer may include a sintered electrode layer including a metal and glass, and a resin electrode layer disposed on the sintered electrode layer and including metal particles and a resin.

The metal particles included in the resin electrode layer may include one or more of spherical particles and flake-shaped particles. The metal particles included in the resin electrode layer may include, for example, Cu, Ni, Pd, Pt, Au, Ag, Pb, Sn, and/or alloys including the same. The resin included in the resin electrode layer may include, for example, one or more of epoxy resin, acrylic resin, and ethyl cellulose.

The plating layer may include, for example, Ni, Sn, Pd, and/or alloys including the same, and may be comprised of a plurality layers. The plating layer may be, for example, a Ni plating layer or a Sn plating layer, and may be formed in a form in which the Ni plating layer and the Sn plating layer are sequentially formed. The plating layer may include a plurality of Ni plating layers and/or a plurality of Sn plating layers.

The drawing illustrates a structure in which a multilayer electronic component 100 has two external electrodes 131 and 132. However, the present disclosure is not limited thereto, and the number and shape of the external electrodes 131 and 132 may vary depending on the shape of the internal electrodes 121 and 122 or other purposes.

The dielectric layer 111 may include Ba and Ti. For example, the dielectric layer 111 may include a perovskite-type compound represented by ABO₃ as a main component. The A may include Ba, and the B may include Ti. The perovskite compound may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1). In the present disclosure, the main component may mean a component that occupies a relatively large proportion as compared to other components, and may mean a component that is 50 wt % or more, or 50 at % or more, based on the content of an entire composition or an entire dielectric layer.

The dielectric layer 111 may include a plurality of dielectric grains 111a and grain boundaries 111b disposed between adjacent dielectric grains. That is, the grain boundaries 111b may refer to a boundary between adjacent dielectric grains, and the dielectric grain 111a may be surrounded by a plurality of grain boundaries 111b. The boundary between the dielectric grain 111a and the grain boundaries 111b may be defined by distinguishing parts having different brightness levels, such as by binarizing an image captured with a transmission electron microscope.

As the thickness of the dielectric layer 111 and the internal electrodes 121 and 122 of the multilayer electronic component 100 decrease, the electric field strength applied to the dielectric layer 111 and the internal electrodes 121 and 122 of a first layer becomes relatively stronger, resulting in potentially reducing the reliability of the multilayer electronic component 100. Meanwhile, the main component of the insulation resistance (IR), which indicates the reliability of the dielectric, is known to be the grain boundary resistance caused by the Schottky-type energy barrier present at the grain boundaries.

The dielectric layer 111 may include Ge. When Ge is distributed at the grain boundaries 111b, Ge acts as an energy barrier that increases grain boundary resistance, thereby improving the reliability of the multilayer electronic component 100. However, when Ge is excessively distributed at the grain boundaries 111b, Ge may cause local electric field concentration as the grain resistance increases irregularly, or may excessively suppress the grain growth of the dielectric grains 111a to deteriorate the reliability of the multilayer electronic component 100. Therefore, in order to improve the reliability of the multilayer electronic component 100, it is necessary to appropriately control the Ge content at the grain boundaries 111b.

According to an example embodiment of the present disclosure, an average Ge content CGB relative to Ti at the grain boundaries 111b may be 0.2 at % or more and 4.5 at % or less. When CGB satisfies the above-described numerical range, the reliability of the multilayer electronic component 100 may be effectively improved.

An example of a method of measuring the average Ge content CGB relative to Ti at a grain boundaries 111b is as follows. First, a longitudinal-thickness cross-section (hereinafter referred to as a measurement cross-section) polished to a center of a multilayer electronic component 100 in the width direction is exposed. Then, a thin film sample for observation with a scanning transmission electron microscope (STEM) is produced through FIB microsampling, and the thin film sample is subjected to Ar ion milling to remove a damaged layer on the surface. Then, an analysis is performed on one point of the grain boundary using an electron beam probe diameter of approximately 0.2 nm. In this case, the analysis is performed only on the grain boundaries 111b, perpendicular to the electron beam. The components of the grain boundaries 111b may be analyzed using an energy dispersive X-ray analyzer (EDS) mounted on a scanning transmission electron microscope (STEM). The content of Ge relative to Ti at the grain boundaries 111b may be measured from a value obtained by dividing the measured content of Ge (at %) by the content of Ti (at %). Additionally, after performing the content measurement at 10 or more grain boundaries 111b and then averaging the measured values, the average Ge content CGB relative to Ti at the grain boundaries 111b may be measured. Other methods and/or tools appreciated by one of ordinary skill in the art, even if not described in the present disclosure, may also be used.

In an example embodiment, an average content (at %) of Ge relative to Ti inside the plurality of dielectric grains 111a may be less than an average content (at %) of Ge relative to Ti at the grain boundaries 111b. Ge may be distributed at the grain boundaries 111b rather than dissolved within the dielectric grains 111a, thereby improving the insulation resistance of the dielectric layer 111. The content of Ge relative to Ti inside the plurality of dielectric grains 111a may be measured by dividing the Ge content (at %) measured via EDS by the Ti content (at %). Furthermore, after performing the content measurement on 10 or more dielectric grains 111a and then averaging the measured values, an average Ge content CDG relative to Ti within the plurality of dielectric grains 111a. Other methods and/or tools appreciated by one of ordinary skill in the art, even if not described in the present disclosure, may also be used.

In an example embodiment, the internal electrodes 121 and 122 may include a Ni—Ge alloy. When Ni and Ge are sintered together in a reducing atmosphere, a Ni—Ge alloy may be uniformly formed on the internal electrodes 121 and 122. The Ni—Ge alloy may reduce the grain boundary energy and surface tension of Ni, thereby improving the smoothness and connectivity of the internal electrodes 121 and 122. When the smoothness of the internal electrodes 121 and 122 is improved, the electric field strength applied to the dielectric layer 111 may be effectively distributed, even when the thickness of the dielectric layer 111 is reduced.

Furthermore, by alloying a metalloid Ge with Ni, the insulation at an interface between the dielectric layer 111 and the internal electrodes 121 and 122 may be improved, thereby enhancing the reliability of the multilayer electronic component 100. Furthermore, since a sintering rate of Ni is delayed during the alloying process with Ge, electrode connectivity may be further improved, thereby enabling the implementation of a multilayer electronic component 100 with higher capacity.

In an example embodiment, an average Ge content CIE relative to Ni in the internal electrodes 121 and 122 may be 0.32 at % or more and 6.3 at % or less. When the above-described numerical range is satisfied, the capacitance and reliability of the multilayer electronic component 100 may be more effectively improved. Furthermore, Ge included in the internal electrodes 121 and 122 may diffuse into the grain boundaries 111b of the dielectric layer 111 during the sintering process. Accordingly, when the CIE satisfies the above-described numerical range, the CGB may be more effectively controlled.

Meanwhile, the internal electrodes 121 and 122 may further include one or more conductive metals, including Cu, Ag, Pd, Au, Al, and Sn, in addition to the Ni—Ge alloy, but the present disclosure is not limited thereto.

The Ge content (at %) relative to Ni in the internal electrodes may be measured by dividing the Ge content (at %) measured at one point inside the internal electrodes 121 and 122 using STEM-EDS by the Ni content (at). Furthermore, the content measurement may be performed at three or more arbitrary points within one internal electrode 121 and 122, and/or at three or more internal electrodes 121 and 122, and then the measured values may be averaged to measure the average Ge content CIE relative to Ni in the internal electrodes. Other methods and/or tools appreciated by one of ordinary skill in the art, even if not described in the present disclosure, may also be used.

Hereinafter, the sub-components that may be included in the dielectric layer 111 will be described in detail. The sub-components described below are based on the number of moles of elements, and may be calculated by converting the amount of an oxide or carbonate added as an additive before sintering. The content of the auxiliary elements may be measured using various methods, such as SEM-EDS, TEM-EDS, and STEM-EDS.

### a) First Sub-Component

The dielectric layer 111 may further include a first sub-component including one or more of Y, Dy, Tb, Ho, Er, Gd, Ce, Nd, Sm, Tm, La and Yb. The first sub-component may improve the high-temperature accelerated lifespan of the multilayer electronic component 100.

The content of the first sub-component may be 2.5 moles or more and 8.0 moles or less with respect to 100 moles of Ti. When the content of the first sub-component is less than 2.5 moles or more than 8.0 moles, room temperature dielectric constant or insulation resistance characteristics may be deteriorated.

The dielectric layer 111 may include, for example, Dy. In an example embodiment, an average Dy content relative to Ti at the grain boundaries 111b may be 2.0 at % or more and 5.0 at % or less. When the above-described numerical range is satisfied, the reliability of the multilayer electronic component 100 may be more effectively improved.

### b) Second Sub-Component

The dielectric layer 111 may further include a second sub-component including one or more of Mn, V, Cr, Fe, Co, Ni, Cu, Co and Zn. The second sub-component may serve to decrease a sintering temperature and to improve dielectric properties, and high-temperature accelerated lifespan characteristics of the multilayer electronic component 100.

The content of the second sub-component may be 0.2 moles or more and 1.4 moles or less with respect to 100 moles of Ti. When the content of the second sub-component is less than 0.2 moles with respect to 100 moles of Ti, there is a concern that the high-temperature acceleration lifespan may deteriorate, and when the content is more than 1.4 moles with respect to 100 moles of Ti, there is a concern that the dielectric constant may deteriorate.

### c) Third Sub-Component

The dielectric layer 111 may further include a third sub-component including magnesium. The third sub-component may impart reduction resistance and may increase an RC value.

The content of the third sub-component may be more than 0 moles and less than or equal to 2.0 moles based on 100 moles of Ti. When the content of the third sub-component is more than or equal to 2.0 moles, there is a concern that TCC may not satisfy the X7R characteristics.

In an example embodiment, an average content of Mg to Ti in the grain boundaries 111b may be 0.2 at % or more and 1.0 at % or less. When the above-described numerical range is satisfied, the reliability of the multilayer electronic component 100 may be more effectively improved.

### d) Fourth Sub-Component

The dielectric layer 111 may further include a fourth sub-component including at least one of Si or Al. Similarly to Ge, Si and/or Al, when distributed at the grain boundaries 111b, may serve as an energy barrier increasing grain boundary resistance, thereby improving the reliability of the multilayer electronic component 100.

Specifically, since Si and/or Al have high chemical stability, Si and/or Al may be relatively uniformly distributed at the grain boundaries 111b, and may also serve to maintain a uniform size of the dielectric grains 111a.

Accordingly, an average Si content (at %) relative to Ti at the grain boundaries 111b may be more than the average Ge content (at %) relative to Ti at the grain boundaries 111b, but the present disclosure is not limited thereto.

Similarly, the average content (at %) of Al relative to Ti at the grain boundaries 111b may be more than the average content (at %) of Ge relative to Ti at the grain boundaries 111b, but the present disclosure is not limited thereto.

The average content (at %) of Si relative to Ti at the grain boundaries 111b may be, for example, 7.0 at % or more and 9.0 at % or less, but the present disclosure is not limited thereto. The average content (at %) of Al relative to Ti at the grain boundaries 111b may be, for example, 8.0 at % or more and 10.0 at % or less, but the present disclosure is not limited thereto.

The average Dy content relative to Ti, an average Mg content relative to Ti, the average Si content relative to Ti, and an average Al content relative to Ti at the grain boundaries 111b may be measured using the same method as the CGB, except that the Dy content (at %), the Mg content (at %), the Si content (at %) and the Al content (at %) are measured using STEM-EDS, instead of the Ge content (at %). Other methods and/or tools appreciated by one of ordinary skill in the art, even if not described in the present disclosure, may also be used.

The average size of the dielectric grains 111a is not particularly limited, but may be 120 nm or more and 200 nm or less. The average size of the dielectric grains 111a may be measured, for example, from an image obtained by capturing the measurement cross-section with a scanning electron microscope (SEM). Other methods and/or tools appreciated by one of ordinary skill in the art, even if not described in the present disclosure, may also be used.

An average thickness td of the dielectric layer 111 is not particularly limited. The average thickness td of the dielectric layer 111 may be, for example, 0.05 μm or more and 2.5 μm or less, 0.05 μm or more to 1.0 μm or less, 0.05 μm or more to 0.5 μm or less, or 0.05 μm or more and 0.4 μm or less.

An average thickness the of the internal electrodes 121 and 122 is not particularly limited. The average thickness the of the internal electrodes 121 and 122 may be, for example, 0.05 μm or more and 1.0 μm or less, 0.05 μm or more and 0.5 μm or less, or 0.05 μm or more and 0.4 μm or less.

The average thickness td of the dielectric layer 111 and the average thickness the of the internal electrodes 121 and 122 may be measured by scanning the measurement cross-section with the scanning electron microscope (SEM) at 10,000× magnification. More specifically, the average thickness td of a dielectric layer 111 may be measured by measuring the thickness at a plurality of points on one dielectric layer 111, for example, five points spaced apart from each other by equal intervals in a longitudinal direction, and then taking an average thereof. Furthermore, the average thickness the of the internal electrodes 121 and 122 may be measured by measuring the thickness at a plurality of points on one internal electrode 121 and 122, for example, five points spaced apart from each other by equal intervals in the longitudinal direction, and then taking an average thereof. The five equally spaced points may be designated in the capacitance formation portion Ac. Furthermore, by performing such average m measurements on ten dielectric layers 111 and ten internal electrodes 121 and 122, respectively, the average thereof, the average thickness td of the dielectric layer 111 and the average thickness the of the internal electrodes 121 and 122 may be more generalized.

An average thickness tc of the cover portions 112 and 113 is not particularly limited. For example, the average thickness of the cover portions 112 and 113 may be 5 μm or more and 100 μm or less, 5 μm or more and 50 μm or less, 5 μm or more and 30 μm or less, or 5 μm or more and 20 μm or less. Here, the average thickness tc of the cover portions 112 and 113 refers to an average thickness of each of the first cover portion 112 and the second cover portion 113, respectively. The average thickness tc of the cover portions 112 and 113 may be a value obtained by averaging the thicknesses measured at five points spaced apart from each other by equal intervals in the longitudinal direction of the measurement cross-section.

Hereinafter, an example of a method of forming a multilayer electronic component 100 will be described. However, the manufacturing method of the multilayer electronic component 100 is not limited thereto.

First, ceramic powder particles for forming a dielectric layer 111 is prepared. The ceramic powder particles may be perovskite compound powder particles represented by ABO₃. The ceramic powder particles may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1). The BaTiO₃ powder particles may be synthesized, for example, by reacting a titanium raw material such as titanium dioxide with a barium raw material such as barium carbonate. Methods of synthesizing the ceramic powder particles include, for example, a solid-state method, a sol-gel method, and a hydrothermal synthesis method, but the present disclosure is not limited thereto. Next, the prepared ceramic powder particles are dried and ground, and then mixed with an organic solvent such as ethanol, a binder such as polyvinyl butyral, and first to fourth sub-component powder particles to prepare a ceramic slurry, and the ceramic slurry is then applied to a carrier film and dried to form a ceramic green sheet.

Next, an internal electrode conductive paste including metal powder particles, a binder, an organic solvent, and the like is printed at a predetermined thickness on the ceramic green sheet using a screen-printing method or a gravure-printing method, thereby forming an internal electrode pattern. The metal powder particles may include, for example, nickel (Ni) powder particles. Furthermore, the metal powder particles may further include one or more of copper (Cu), silver (Ag), pd (Pd), gold (Au), aluminum (Al) and tin (Sn) powder particles.

The internal electrode conductive paste may include GeO₂ powder particles. The content of the GeO₂ powder particles in the internal electrode conductive paste is not particularly limited, but may be 0.5 wt % or more and 10 wt % or less relative to nickel (Ni).

Then, the ceramic green sheet on which the internal electrode pattern is printed is peeled off from the carrier film, and then a predetermined number of ceramic green sheets on which the internal electrode pattern is printed are stacked and pressed to form a ceramic laminate. A predetermined number of ceramic green sheets in which the internal electrode pattern is not formed may be stacked in upper and lower portions of the ceramic laminate to form cover portions 112 and 113 after sintering. Then, the ceramic laminate is cut by a predetermined chip size, and the cut chips are sintered to form a body 110 including the dielectric layer 111 and the internal electrodes 121 and 122. The sintering may be performed, for example, in 1.0% H₂/99.0% N₂ to 3.5% H₂/96.5% N₂ (H₂O/H₂/N₂ atmosphere) at a temperature of 1000° C. or higher and 1400° C. or lower for 1 to 3 hours.

During the sintering process, Ni and Ge are alloyed, so the internal electrodes 121 and 122 may include a Ni—Ge alloy. Furthermore, Ge included in the conductive paste for the internal electrodes may diffuse into the dielectric layer 111 during the sintering process, and the diffused Ge may be distributed at grain boundaries 111b, thereby controlling the average Ge content relative to Ti at the grain boundaries. However, the present disclosure is not limited thereto, and the average Ge content relative to Ti at the grain boundaries may also be controlled by separately adding GeO₂ powder particles to the ceramic slurry used to form the dielectric layer 111.

Next, the external electrodes 131 and 132 are formed. For example, when a base electrode layer includes a sintered electrode layer, the body 110 may be dipped in a conductive paste for external electrodes including metal powder particles, glass frit, a binder and an organic solvent, and then the conductive paste for external electrodes may be sintered at a temperature of 500° C. to 900° C. to form the sintered electrode layer.

For example, when the base electrode layer includes a resin electrode layer, the body may be dipped in a conductive resin composition including metal powder particles, a resin, a binder and an organic solvent, and may then be heat-cured at a temperature of 250° C. to 550° C., thus forming a resin electrode layer.

Additionally, electrolytic plating and/or electroless plating may be additionally performed to form a plating layer on the base electrode layer.

### EXAMPLES

Hereinafter, the present disclosure will be described in more detail through examples. However, the following examples are intended to aid in a concrete understanding of the present disclosure and are not intended to limit the scope of the present disclosure.

Using the above-described method, 0603-sized sample chips (length: approximately 0.6 mm, width: approximately 0.3 mm, thickness: approximately 0.3 mm) were manufactured, but the sample chips of the examples and comparative examples were manufactured by adjusting the content of GeO₂ relative to Ni in the conductive paste for the internal electrodes from 0 wt % to 12 wt %.

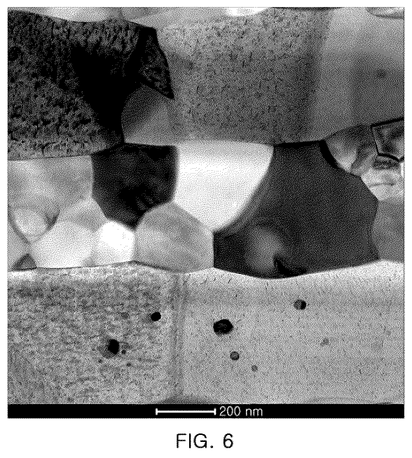

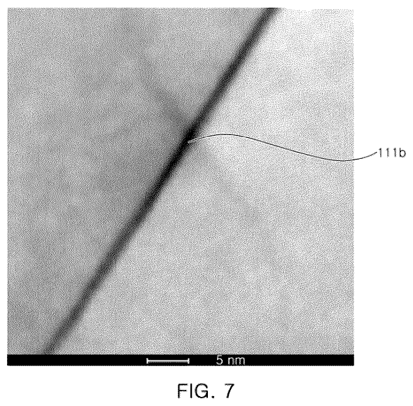

Then, a longitudinal-thickness cross-section was exposed by polishing a widthwise center of each sample chip, and then, film samples for scanning transmission electron microscopy (STEM) observation were produced through FIB microsampling. The surface damage layer was then removed using Ar ion milling, and STEM-EDS analysis was performed under conditions of an acceleration voltage of 200 kV and a probe diameter of 0.2 nm. FIG. 6 is an image obtained by capturing a dielectric layer and internal electrode using a scanning transmission electron microscope (STEM). FIG. 7 is an image of the grain boundaries 111b of the dielectric layer using the STEM.

The Ge content (at %) relative to Ti was then measured at 10 grain boundaries, perpendicular to the electron beam, and also, such content measurements were performed on 20 sample chips for each of the comparative examples and examples, and an average value thereof was then calculated to derive the average Ge content CGB relative to Ti at the grain boundaries.

Similarly, the Ge content relative to Ti was measured at three arbitrary points within the internal electrode using STEM-EDS, and also, such content measurements were performed on 20 sample chips for each of the comparative examples and the examples, and an average value was calculated to derive the average Ge content CIE relative to Ni in the internal electrode.

Then, 40 samples each from the comparative examples and the examples were subjected to high-temperature accelerated lifespan evaluations at 125° C. and 9.5 V, and the mean time to failure (MTTF) values were measured. In this case, a time when the insulation resistance is 10 kΩ or less was used as a failure time, and the MTTF value of Comparative Example 1 was used as a reference value 1, from which relative values of other examples and comparative examples were listed

TABLE 1

| Division | GeO₂/Ni (wt %) | C_{GB} (at %) | C_{IE} (at %) | MTTF |
|---|---|---|---|---|
| Comparative | 0 | 0 | 0 | 1 |
| Example 1 | | | | |
| Comparative | 0.2 | 0 | 0.14 | 1 |
| Example 2 | | | | |
| Example 1 | 0.5 | 0.2 | 0.32 | 1.07 |
| Example 2 | 1 | 0.4 | 0.7 | 1.12 |
| Example 3 | 3 | 1.4 | 1.9 | 1.18 |
| Example 4 | 5 | 2.6 | 3.2 | 1.25 |
| Example 5 | 10 | 4.5 | 6.3 | 1.15 |
| Comparative | 12 | 5.2 | 7.5 | 0.81 |
| Example 3 | | | | |

Referring to Table 1, for Example 1 and Comparative Example 2, in which the CGB was less than 0.2 at %, it may be confirmed that the MTTF of the sample chips did not improve. However, when the CGB was 0.2 at % or higher, the MTTF was significantly improved. However, for Comparative Example 3, it may be confirmed that when the CGB exceeded 4.5 at %, the excessive inclusion of Ge within the grain boundaries resulted in a decrease in the MTTF.

Thus, as in Examples 1 to 5, it may be confirmed that when the average Ge content CB relative to Ti at the grain boundaries was satisfied to be 0.2 at % or more and 4.5 at % or less, the reliability of the multilayer electronic components was significantly improved.

The present disclosure is not limited to the above-described example embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ used in the present disclosure does not denote the same example embodiment, and is provided to emphasize and explain different unique characteristics. However, the example embodiments presented above do not preclude being implemented in combination with the features of another example embodiment. For example, although items described in a specific example embodiment are not described in another example embodiment, the items may be understood as a description related to another example embodiment unless a description opposite or contradictory to the items is in another example embodiment.

In the present disclosure, a meaning of being connected is a concept including not only directly connected but also indirectly connected through an adhesive layer or the like. Furthermore, a meaning of electrically connected is a concept including both physically connected and not connected. In addition, expressions such as first and second are used to distinguish one component from another, and do not limit the order and/or importance of the components. In some cases, a first component may be referred to as a second component without departing from the scope of rights, or similarly, the second component may be referred to as the first component.

What is claimed is:

1. A multilayer electronic component, comprising:
a body including a dielectric layer including Ba, Ti, and Ge, and internal electrodes disposed alternately with the dielectric layer; and
an external electrode disposed on the body,
wherein the dielectric layer includes a plurality of dielectric grains, and grain boundaries disposed between adjacent dielectric grains, and
an average Ge content relative to Ti at the grain boundaries is 0.2 at % or more and 4.5 at % or less.

2. The multilayer electronic component according to claim 1, wherein the internal electrodes include a Ni—Ge alloy.

3. The multilayer electronic component according to claim 2, wherein an average Ge content relative to Ni in the internal electrodes is 0.32 at % or more and 6.3 at % or less.

4. The multilayer electronic component according to claim 1, wherein an average Ge content (at %) relative to Ti inside the plurality of dielectric grains is less than the average Ge content (at %) relative to Ti at the grain boundaries.

5. The multilayer electronic component according to claim 1, wherein the dielectric layer includes a main component that includes a perovskite-type compound represented by ABO₃,
wherein the A includes Ba and the B includes Ti.

6. The multilayer electronic component according to claim 1, wherein the dielectric layer further includes one or more selected from the group consisting of Y, Dy, Tb, Ho, Er, Gd, Ce, Nd, Sm, Tm, La and Yb.

7. The multilayer electronic component according to claim 1, wherein the dielectric layer further includes one or more selected from the group consisting of Mn, V, Cr, Fe, Co, Ni, Cu and Zn.

8. The multilayer electronic component according to claim 1, wherein the dielectric layer further includes Mg.

9. The multilayer electronic component according to claim 1, wherein the dielectric layer further includes at least one selected from the group consisting of Si and Al.

10. The multilayer electronic component according to claim 1, wherein an average Si content (at %) relative to Ti at the grain boundaries is more than the average Ge content (at %) relative to Ti at the grain boundaries.

11. The multilayer electronic component according to claim 1, wherein an average Al content (at %) relative to Ti at the grain boundaries is more than the average Ge content (at %) relative to Ti at the grain boundaries.

12. The multilayer electronic component according to claim 1, wherein an average Dy content relative to Ti at the grain boundaries is 2.0 at % or more and 5.0 at % or less.

13. The multilayer electronic component according to claim 1, wherein an average Mg content relative to Ti at the grain boundaries is 0.2 at % or more and 1.0 at % or less.

14. The multilayer electronic component according to claim 1, wherein an average size of the plurality of dielectric grains is 120 nm or more and 200 nm or less.

15. A method of manufacturing the multilayer electronic component according to claim 1, comprising:
applying a slurry to a film to form a plurality of ceramic green sheets,
applying a first paste to each ceramic green sheet among the plurality of ceramic green sheets,
stacking the plurality of ceramic green sheets to form a laminate,
sintering the laminate to form the body, and
applying a second paste to the body to form the external electrode,
wherein either the first paste or the slurry includes GeO₂.

16. The method according to claim 15, wherein the first paste includes GeO₂.

17. The method according to claim 16, wherein the first paste further includes Ni, and a Ge content relative to Ni is 0.5 wt % or more and 10 wt % or less.

18. The method according to claim 15, wherein the slurry includes GeO₂.
